(19) United States
(12) Patent Application Publication
(10) Pub. No.: US 2026/0204002 A1
(43) Pub. Date: Jul. 16, 2026

(54) TRAINING OF A MACHINE LEARNING MODEL TO GENERATE A 3D IMAGE

(71) Applicant: GOOGLE LLC, Mountain View, CA (US)

(72) Inventors: Srivignesh Rajendran, Santa Clara, CA (US); John Patrick Flynn, Los Angeles, CA (US); Michael Joseph Broxton, Los Gatos, CA (US); Ryan Styles Overbeck, Mountain View, CA (US); Clément Louis Jean-Claude Godard, San Francisco, CA (US); Kathryn Heal, Los Angeles, CA (US); Lukas Murmann, San Mateo, CA (US); Daniel William Erickson, Oakland, CA (US)

(21) Appl. No.: 19/134,980

(22) PCT Filed: Dec. 12, 2023
(86) PCT No.: PCT/US2023/083648

§ 371 Date: Jun. 2, 2025

Related U.S. Application Data
(63) Continuation of application No. PCT/US2023/079864, filed on Nov. 15, 2023.
(60) Provisional application No. 63/387,002, filed on Dec. 12, 2022.
(60) Provisional application No. 63/387,004, filed on Dec. 12, 2022.

(51) Int. Cl. G06T 15/20; G06F 3/01; G06T 17/20

(52) U.S. Cl. CPC G06T 15/205; G06T 17/20; G06F 3/013

(57) ABSTRACT

A method including in a first training process, receiving first 2D training images, generating a scene representation based on the first 2D training images using a machine learning model, generating a loss based on comparing the scene representation to a ground-truth scene representation, and training the machine learning model based on the loss, and in a second training process, receiving a first video frame including second 2D training images, receiving a second video frame including third 2D training images the first frame and the second frame being captured sequentially in time, generating a first intermediate prediction based on the first video frame using the machine learning model, generating a second intermediate prediction based on the second video frame using the machine learning model, generating a loss based on the first intermediate prediction and the second intermediate prediction, and training the machine learning model based on the loss.

### CROSS-REFERENCE TO RELATED APPLICATION

This application claims the benefit of U.S. Provisional Application No. 63/387,002, filed on Dec. 12, 2022, and U.S. Provisional Application No. 63/387,004, filed Dec. 12, 2022. This application also claims priority to PCT Application No. PCT/US2023/079864, filed Nov. 15, 2023, the disclosures of all applications listed above are incorporated herein by reference in their entireties.

### FIELD

Embodiments relate to rendering three-dimensional left-eye and right-eye images.

### BACKGROUND

Generating a three-dimensional (3D) image from a plurality of two-dimensional (2D) images can involve stitching of the 2D images. A stitching operation can include computing all possible translations (x, y, z) between two 2D images with relation to a 3D perspective simultaneously. Computing the translations can determine the best overlap with regard to a cross-correlation measure. If more than two input images are used, the correct placement of portions of the images (sometimes called tiles) can be globally optimized (e.g., the resultant 3D image is modified to remove gaps and overlaps).

### SUMMARY

Example implementations describe a neural rendering and view synthesis system configured to synthesize two viewpoint perspectives (e.g., left-eye and right-eye) based on the eye positions of a receiver-side viewer of a streaming sequence of 3D images. The 3D images can be synthesized based on a plurality of 2D images and rendered prior to streaming the sequence of 3D images.

In a general aspect, a device, a system, a non-transitory computer-readable medium (having stored thereon computer executable program code which can be executed on a computer system), and/or a method can perform a process with a method including including in a first training process, receiving first 2D training images, generating a scene representation based on the first 2D training images using a machine learning model, generating a loss based on comparing the scene representation to a ground-truth scene representation, and training the machine learning model based on the loss, and in a second training process, receiving a first video frame including second 2D training images, receiving a second video frame including third 2D training images the first frame and the second frame being captured sequentially in time, generating a first intermediate prediction based on the first video frame using the machine learning model, generating a second intermediate prediction based on the second video frame using the machine learning model, generating a loss based on the first intermediate prediction and the second intermediate prediction, and training the machine learning model based on the loss.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting of the example embodiments and wherein:

FIG. 1 illustrates a block diagram of an example training signal flow in a machine learning system according to an example implementation.

FIG. 2 illustrates a block diagram of an example machine learning subsystem according to an example implementation.

FIG. 3 illustrates a block diagram of a temporally regularized training flow according to an example implementation.

FIG. 4 illustrates a block diagram of intermediate outputs in training the machine learning model according to an example implementation.

FIG. 5 illustrates a block diagram of a client-based streaming pipeline according to an example implementation.

FIG. 6 illustrates a block diagram of a cloud-based streaming pipeline according to an example implementation.

FIG. 7 illustrates a block diagram of a view synthesis system according to an example implementation.

FIG. 8A illustrates a block diagram of an example machine learning downsampling network according to an example implementation.

FIG. 8B illustrates a block diagram of an example machine learning view synthesis network according to an example implementation.

FIG. 8C illustrates a block diagram of an example machine learning upsampling network according to an example implementation.

FIG. 9 illustrates another block diagram of a view synthesis system according to an example implementation.

FIG. 10 illustrates a camera rig according to an example implementation.

FIG. 11 illustrates a block diagram of a method of synthesizing 3D video according to an example implementation.

FIG. 12 illustrates a block diagram of a method of training a machine learning model according to an example implementation.

It should be noted that these Figures are intended to illustrate the general characteristics of methods, and/or structures utilized in certain example embodiments and to supplement the written description provided below. These drawings are not, however, to scale and may not precisely reflect the precise structural or performance characteristics of any given embodiment and should not be interpreted as defining or limiting the range of values or properties encompassed by example embodiments. For example, the positioning of modules and/or structural elements may be reduced or exaggerated for clarity. The use of similar or identical reference numbers in the various drawings is intended to indicate the presence of a similar or identical element or feature.

### DETAILED DESCRIPTION

Generating a 3D image by stitching a plurality of 2D images may not be sufficiently fast for real-time streaming of 3D images. In other words, capturing and stitching 2D images in a real-time 3D streaming application can be too slow to provide the desired user experience. Existing solutions may reduce the resolution (e.g., number of pixels) to a very low resolution, and still may not achieve the framerate or frames per second (fps) desired for real-time streaming of 3D images.

Client-based architectures or client stations can be expensive with the bulk of the expense being the compute operations and/or hardware (GPUs+CPU+motherboard). Client-based architectures or client stations can be expensive and inflexible due to maintenance and/or upgrades. For example, a problem can be that an algorithm can be tightly coupled with the hardware at the client station(s) limiting the ability to upgrade the algorithm. In other words, upgrading the algorithm may require upgrading the client station(s), which can result in undesirable upgrade delays and costs. Another problem is that client-based architectures or client stations can generate excessive amounts of heat. Without a cooling system in place in the client station room, it becomes uncomfortable for the user resulting in an undesirable user experience.

These problems can be solved by generating a 3D image by using a trained machine learning model with a plurality of 2D images as input. In addition, the trained machine learning model can be implemented as a cloud-based (e.g., on a network device) computing process. Therefore, the client may capture 2D images and communicate the 2D images to the cloud-based architecture to process the 2D images by the trained machine learning model. This cloud-based implementation can reduce the expense and inflexibility of the client-based architecture by minimizing the processing performed by the client-based architecture. In addition, this cloud-based implementation can process the 2D images sufficiently fast for real-time streaming of 3D images.

Example implementations described herein can use a trained machine learning model for synthesizing a 3D mesh from a plurality of 2D images. Example implementations can further use a trained machine learning model to render the synthesized 3D mesh to generate two 3D images each with a viewpoint perspective (e.g., left-eye and right-eye). The 3D images can then be streamed to a 3D playback device. Example implementations can stream the 3D images at a sufficiently high resolution (e.g., 4K) and framerate (e.g., 30 fps) in a real-time 3D streaming application to provide the desired user experience. Example implementations can be implemented as a cloud-based architecture. In other words, example implementations can be performed by a processor and memory associated with a network server. Including the computing in the cloud can enable upgrade hardware and/or software as upgrades get implemented.

A trained machine learning model for synthesizing a 3D mesh from a plurality of 2D images can be a single time-step model. However, temporal inconsistency artifacts and/or floating texture artifacts can occur in a single time-step model. To overcome this problem, some implementations can use temporal information during training in order to time stabilize the view synthesis model of some implementations. Some implementations can introduce temporal stability to a machine learning model (e.g., a view synthesis model), while remaining within the same computational budget of the machine learning model. One of the common reasons for avoiding temporal information at inference is the additional compute requirements necessary for processing more timesteps. In order to circumvent this challenge, some implementations can introduce temporal stability during training with a temporally aware training process.

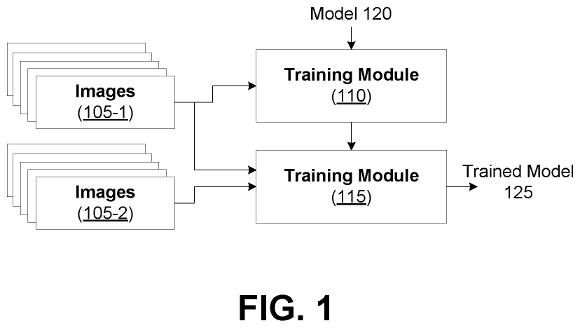

FIG. 1 illustrates a block diagram of an example training process signal flow in a machine learning system according to an example implementation. The training process signal flow can include training module 110 and training module 115. The training process signal flow can receive images 105-1 and output a trained machine learning model 125 based on machine learning model 120. In some implementations, training module 110 and training module 115 can be included in a single module configured to perform the functions and/or operations of training module 110 and training module 115.

The training process can include a first training operation, using training module 110, that trains the machine learning model 120 without considering temporal information. The first training operation, using training module 110, can be complete when training the machine learning model 120 approaches (or reaches) a convergence on a solution. The solution can be based on, for example, a threshold amount of error. The solution can be based on, for example, a minimal amount of loss. A minimal amount of loss or error can represent an ideal solution.

In some implementations, images 105-1 can be training images. Images 105-1 can represent an image or a frame of a video. Images 105-1 can be captured by a camera rig, stored in a memory and received (from the memory) by training module 110. Images 105-1 can include a plurality of 2D images. In some implementations, a scene representation can be generated based on images 105-1 using a machine learning model 120. The machine learning model 120 can be configured to generate a 3D image based on the images 105-1. The machine learning model 120 can be configured to synthesize a 3D image based on the images 105-1. The machine learning model 120 can be configured to synthesize a 3D representation of a scene sometimes called a layered mesh (described in more detail below). The machine learning model 120 can be configured to synthesize a layered mesh where each layer of the mesh can sometimes be called a depth layer. In some implementations the machine learning model 120 (or an image rendering operation) can be configured to render a 3D multiplane image (MPI) where each plane has a depth. A plane depth or depth layer can include depth information and features associated with the scene at the associated depth.

In some implementations, a loss can be generated based on comparing the scene representation to a ground-truth scene representation. The loss can be generated based on (or using) a loss function measuring the disagreement between predicted and observed measurements. The predicted measurements can be the scene representation. The observed measurements can be the ground-truth scene representation. The predicted measurements can be a predicted MPI. The observed measurements can be a ground-truth MPI. Therefore, the loss can be based on a comparison of an image generated using the predicted MPI and a ground-truth image or, alternatively, an image generated using the ground-truth MPI. The loss function can be a feature loss associated with a difference between the predicted MPI and the ground-truth MPI. In some implementations, the machine learning model 120 can be trained based on the loss. In some implementations, the machine learning model 120 can be trained across a large variety of scene representations (e.g., based on a variety of images 105-1), using stochastic gradient descent over a plurality of iterations.

In some implementations, the loss (e.g., the loss of eqn. 3 below) can have three (3) components. The first component (L) uses Learned Perceptual Image Patch Similarity (LPIPS) to measure the difference between a ground truth image and an image rendered by the network. The second component (L_density) compares the density predicted by the network between successive frames (density_{t−1}-density_t). The third component (L_{blend-weight}) compares the blend weights predicted by the network between successive frames (blendWeight_{t−1}-blendWeight_{t}). The density and blendWeight losses both use a simple L1 loss.

In some implementations, the first component can aim to make the best possible rendering for a frame. The second two losses can penalize changes in the outputs, so that the network will try to produce the best quality results while minimizing the amount of change between frames. By minimizing the change between frames, we can reduce temporal inconsistencies, sometimes called flicker.

In some implementations, a second training operation, using training module 115, can be used to train the machine learning model 120 while considering temporal information. For example, the second training operation, using training module 115, can include inputting a dataset with two time-step inputs (e.g., images 105-1 and 105-2) to the machine learning model 120. The dataset can be sequential in that two consecutive frames of a video can be input to the machine learning model 120. In some implementations, a second training operation, using training module 115, can train the machine learning model 120 after the machine learning model 120 has been trained using the first training operation, using training module 110.

The second training operation, using training module 115, can include enforcing that the intermediate outputs in the machine learning model 120 as a temporally aware machine learning model remain consistent across time (see, for example, density and blend weight regularization described below). In an example implementation, the training datasets (e.g., images 105-1, 105-2 as video frames) can be captured at 30 or 60 frames per second. Therefore, there is very little motion between subsequent frames. Therefore, in-order to model the scene's geometry, the machine learning model 120 can largely have the exact same scene geometry between two frames. The second training operation, using training module 115, can include repeatedly inputting two time-step inputs (e.g., images 105-1, 105-2 as video frames) and training the machine learning model 120 to a convergence on an ideal solution (e.g., a loss) while enforcing that the intermediate outputs in the trained machine learning model 125 (or training iterations thereof) as a trained temporal aware machine learning model remain consistent across time. In some implementations, training the machine learning model 120 can include repeating (e.g., in iterations) the first training process until the loss is minimized and in each iteration a weight(s) associated with the machine learning model 120 can be changed.

In some implementations, images 105-1 and 105-2 can represent video frames including training images that are captured by a camera rig for training purposes. Images 105-1, 105-2 can be captured by a camera rig, stored in a memory and received (from the memory) by training module 115. Images 105-1, 105-2 can include a plurality of 2D images. Images 105-1 and 105-2 can represent video frames that have been captured sequentially in time. Images 105-1 and 105-2 can represent video frames that have been captured close in time. For example, images 105-1 and 105-2 can represent video frames captured at a high frame rate (e.g., 30, 45, 60, and the like frames per second (fps)).

In some implementations, a first intermediate prediction can be generated based on the video frame corresponding to images 105-1 using the machine learning model 120 and a second intermediate prediction can be generated based on the video frame associated corresponding to images 105-2 using the machine learning model 120. As mentioned above, the machine learning model 120 can be configured to synthesize a layered mesh where each layer of the mesh can sometimes be called a depth layer. In some implementations the machine learning model 120 (or an image rendering operation) can be configured to render a 3D multiplane image (MPI) where each plane has a depth. A plane depth or depth layer can include depth information and features associated with the scene at the associated depth.

In some implementations, the intermediate prediction can include a density and a blend weight. The density and weight can be associated with the layered mesh and/or MPI. The density can be the transparency of each layer. Therefore, the density can indicate how much a viewer can see through a given layer of the layered mesh and/or MPI and the amount of the layers behind the layer are visible. In some implementations, the intermediate prediction of the blend weight can be a (e.g., one) blend weight for each input image, and the value can indicate the amount of the RGB color to use from that input image to color a pixel of the MPI or layered mesh. To choose which RGB color to pull from the input image, a ray can be traced from the camera of the input image through the point on the MPI and/or layered mesh, and where the traced ray intersects the input image determines the input image pixel. In some implementations, the density and blend weights are output attributes of the network and are mapped to pixels in the MPI or layered mesh.

In some implementations, a loss can be generated based on comparing the intermediate prediction associated with the video frame corresponding to images 105-1 and the second intermediate prediction associated with the video frame corresponding to images 105-2 (see eqns. 1-3 below). The loss can be a difference (e.g. L1 loss) between the density and blend weights in successive frames. This can encourage the machine learning model 120 to choose solutions that minimize the difference between successive frames. In other words, the machine learning model 120 can tend to produce flickering resulting in areas where the density or blend weights that should be in a part of the MPI or layered mesh is not certain (or the prediction is uncertain). For example, the machine learning model 120 effectively guesses, and when the guess is different in subsequent frames, flicker can occur. These losses have the impact of encouraging the machine learning model 120 to make guesses that are less likely to change significantly in subsequent frames and hence reduces flicker.

In some implementations, the machine learning model 120 can be trained based on the loss. In some implementations, the machine learning model 120 can be trained across a large number of frames. In some implementations, because the video frames can be captured at a high frame rate, there should be little to no loss between intermediate prediction associated with the video frame corresponding to images 105-1 and the second intermediate prediction associated with the video frame corresponding to images 105-2. Training the machine learning model 120 based on the loss between intermediate predictions can temporally regularize the machine learning model 120. In some implementations, training the machine learning model 120 can include repeating (e.g., in iterations) the first training process until the loss is minimized and in each iteration a weight(s) associated with the machine learning model 120 can be changed. In response to completing the training of the machine learning model 120, the machine learning model 120 can be considered the trained machine learning model 125

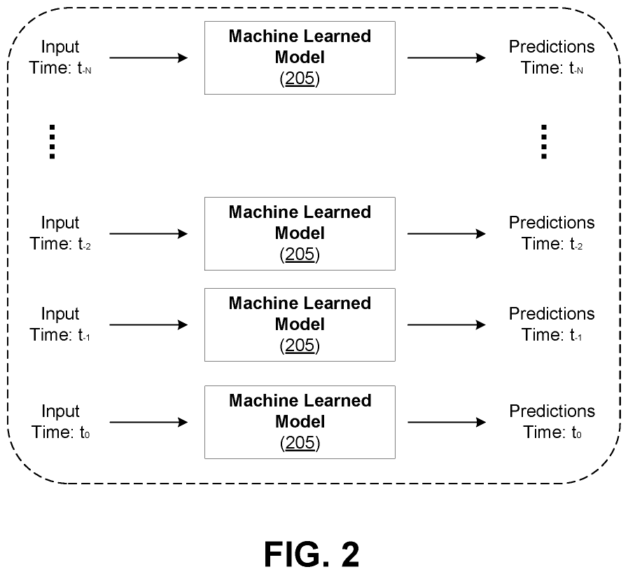

FIG. 2 illustrates a block diagram of an example machine learning subsystem according to an example implementation. In some implementations, the machine learning subsystem can be time independent. At each timestep (e.g., Time t₀ to Time t_{N}) a set of input images (not shown) can be received and input to a machine learning model 205. The machine learning model 205 can generate and/or predict a geometry and blend weights for the corresponding timestep (e.g., Time t₀ to Time t_{N}). In processing each time step (e.g., Time t₀ to Time t_{N}) independently, a temporal coherence can be lost. In addition, temporal artifacts can be generated. By not leveraging temporal information, the ability to clean up noise or floating textures that don't belong in the scene can be impeded.

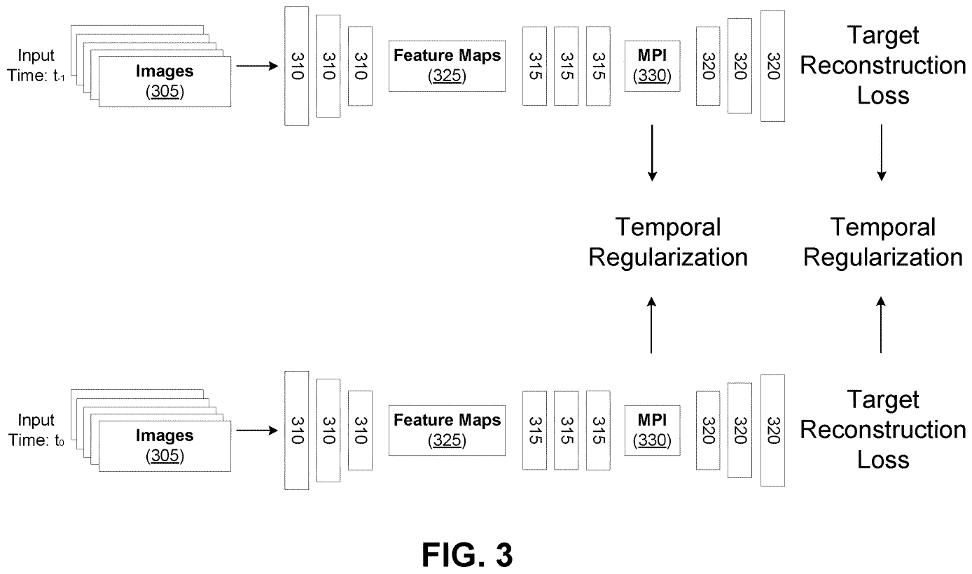

FIG. 3 illustrates a block diagram of an example machine learning subsystem according to an example implementation. The machine learning subsystem can include a downsampling element including blocks 310. The downsampling element including blocks 310 can be configured to generate feature maps 325 based on images 305. The machine learning subsystem can include a view synthesis core including blocks 315. The view synthesis core including blocks 315 can be configured to generate multiplane image (MPI) 330 based on feature maps 325. The machine learning subsystem can include an upsampling element including blocks 320. The upsampling element including blocks 320 can be configured to generate a representation of a scene based on the MPI 330.

FIG. 3 illustrates a block diagram of a temporally regularized training flow according to an example implementation. In order to temporally regularize the machine learning model, consecutive images 305 (e.g., frames of a video) (denoted by time t₀ and t₋₁) are input during the training of the machine learning model. In the example implementation, t₀ indicates the current and t₋₁ indicates the previous frame. Once the model makes intermediate predictions such as blend weights and densities, the training of the machine learning model can enforce that the densities be the same across both time steps with an L1 loss. For example:

$${L}_{density} = \vert {density}_{t - 1} - {density}_{t} \vert \qquad ( eq . 1 )$$

$${L}_{blend - weight} = \vert {blendWeight}_{t - 1} - {blendWeight}_{t - 1} \vert \qquad ( eq . 2 )$$

$${L}_{total} = {L}_{τ achyon} + ( {α}_{density} * {L}_{density} ) + ( {α}_{blend} * {L}_{blend - weight} ) \qquad ( eq . 3 )$$

A model is typically trained with a loss L. Example implementations introduce a loss L1 configured to encourage minimal change in density and blend weights across different time steps (e.g., minimal change over time) in eq. 1 and eq. 2.

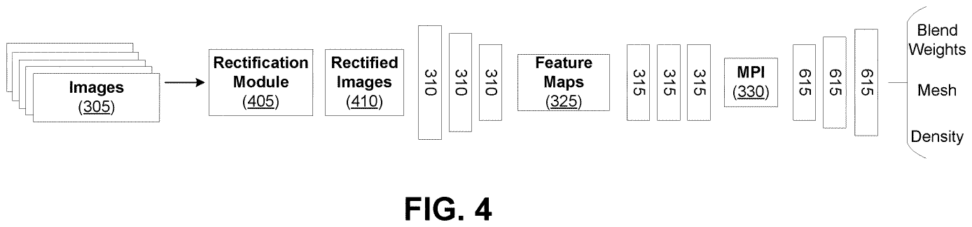

FIG. 4 illustrates a block diagram of intermediate outputs in training the machine learning model according to an example implementation. The machine learning model can include a rectification module 405. The rectification module 405 can be configured to generate rectified images 410. The machine learning model can include the downsampling element including blocks 310. The downsampling element including blocks 310 can be configured to generate feature maps 325 based on rectified images 410. The machine learning model can include the view synthesis core including blocks 315. The view synthesis core including blocks 315 can be configured to generate multiplane image (MPI) 330 (or a feature layered mesh) based on feature maps 325. The machine learning model can include the upsampling element including blocks 320. The upsampling element including blocks 320 can be configured to generate intermediate outputs including blend weights, a mesh and a density based on the MPI 330.

The final training loss for the temporally regularized machine learning model can be described in eq. 3, which is a weighted sum of the original machine learning model training loss, combined with the weighted sum of temporal regularization loss functions. The weights themselves can be hand-tuned (e.g., manually picked), but the weights can also be hyper-parameter tuned on large scale clusters. Introducing temporal regularization can greatly reduce the floating artifacts and the machine learning model has been more temporally smooth and create a more realistic telepresence experience.

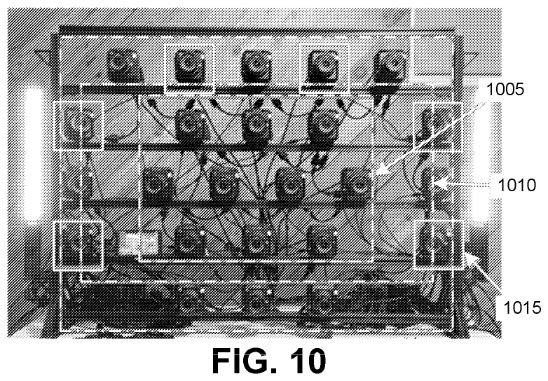

As mentioned above, the training process can include a first training operation that trains the machine learning model without considering temporal information. Training data can include a training data tuple. Each training data tuple can include a set of input views and a crop within a target view. The machine learning model design can allow changing the number of planes and their depths after training. However, the machine learning model may overfit the specific inter-plane spacing used during training. This overfitting can be mitigated by applying a random jitter to the depths of the multiplane image planes during training. A training loss function can use feature similarity where the training loss L_{f}, specifically the conv1 2, conv2 2 and conv3 3 layers of a pre-trained machine learning model and adopt a per layer scaling method. Training the machine learning model can use training parameters in a machine learning platform (e.g., TensorFlow) and use an optimizer based on, for example, a gradient descent algorithm with learning rate equal to, for example, 0.00015. The supplemental material and Table 1 further describe the hyperparameters and the training setup used in experiments. Training data can be captured using, for example, the camera rig of FIG. 10.

In FIG. 10 the cameras in box 1010 can be screen edge cameras used for input views, the cameras in box 1015 can be the input cameras, and the cameras inside box 1005 can be witness cameras. The cameras inside box 1005 (or witness cameras) can be used for ground-truth comparisons. During training, the network generates a layered mesh, and the layered mesh can be rendered to the viewpoints of each of the cameras inside box 1005 (or witness cameras). The rendered results can be compared to the witness camera image and compute a learned perceptual image patch similarity (LPIPS) loss between the two. That provides the gradients to backpropagate and improve upon. In an example implementation, the temporal regularization can generate an additional loss that is combined with the LPIPS loss.

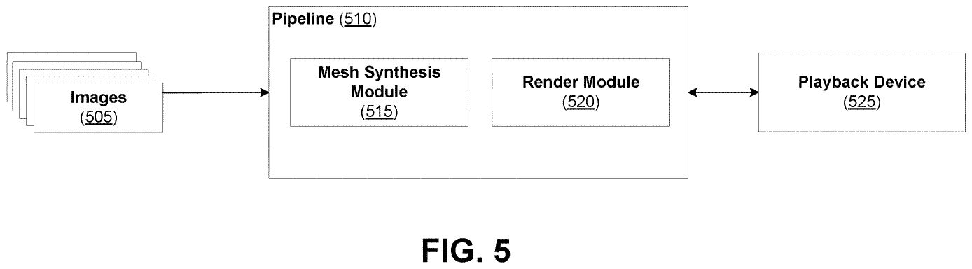

FIG. 5 illustrates a block diagram of a client-based streaming pipeline according to an example implementation. As shown in FIG. 5, a streaming pipeline 510 (e.g., 3D streaming pipeline) can include a mesh synthesis module 515 and a render module 520. The 3D streaming pipeline 510 can be configured to receive a plurality of 2D images 505 and generate two 3D images that can be streamed to a playback device 525.

A plurality of cameras (e.g., a camera rig) can be configured to capture the plurality of 2D images 505. In an example implementation, the plurality of cameras (e.g., six cameras) can be rolling shutter RGB cameras that are time synchronized and share exposure and white balance settings. The plurality of 2D images 505 can represent an image or a frame of a video. In an example implementation, the plurality of cameras may not capture depth. Therefore, the plurality of 2D images 505 may not include depth information. In an example implementation the 3D streaming pipeline 510 can be on the same device (e.g., a sending station) as the plurality of cameras. In this example implementation, as a frame(s) is captured, the plurality of 2D images 505 can be processed in-line by the 3D streaming pipeline 510.

In an example implementation the 3D streaming pipeline 510 can be on a different device (e.g., a server) than the plurality of cameras. In this example implementation, as a frame(s) is captured, the plurality of 2D images 505 can be compressed using, for example, the HEVC (h.265) standard at 25 Mbps per camera and then communicated to the server to be processed by the 3D streaming pipeline 510. In this implementation, the plurality of 2D images 505 can be decompressed and processed by the 3D streaming pipeline 510.

The mesh synthesis module 515 can be configured to synthesize or fuse the plurality of 2D images 505 into a 3D representation of a scene sometimes called a layered mesh (e.g., layered mesh 20 described in more detail below) and the render module 520 can be configured to render the layered mesh as a 3D image representation of a scene. In an example implementation, the layered mesh can represent the complete 3D scene based on the plurality of 2D images 505. In other words, the layered mesh has not been configured to render almost any particular viewpoint perspective (e.g., left-eye and right-eye) of a user viewing the playback device 525. Further, the layered mesh can be used to render any potential viewpoint perspective of a user viewing the playback device 525. Further, the layered mesh can be used to render any potential viewpoint perspective of a user viewing the playback device 525. In other words, the synthesized layered mesh can represent any view perspective corresponding to any head position such that, when displayed on the playback device 525, left eye and right eye images that are rendered based on the synthesized layered mesh can have a view perspective that can be modified with six degrees of freedom (DoF) based on the users view perspective and/or head position.

The render module 520 can be configured to render two images and generate two depth maps (e.g., one for each of the user's eyes viewing the playback device 525). The two images can be RGB and depth map views. In an example implementation, the playback device 525 can communicate a current or last viewpoint perspective and/or head pose of the user viewing the playback device 525. Therefore, the render module 520 can be configured to render the two images and generate the two depth maps (e.g., RGB and depth map views) based on the current or last viewpoint perspective and/or head pose of the user. The rendered images and generated depth maps can be streamed (e.g., communicated) to the playback device 525 at, for example, a 4K resolution and 30 fps.

In an example implementation, the playback device 525 can be configured to perform a last-second reprojection of the rendered images and generated depth maps using the latest viewpoint perspective and/or head pose of the user estimate before rendering to the display of the playback device 525. The reprojection can adjust for user movement (e.g., a change in viewpoint perspective and/or head pose) during the streaming process (e.g., due to system and/or streaming latency).

In the Example of FIG. 5, a majority of the computing can be performed at the client stations and the video streams can be routed through the cloud but no significant computing operations are performed in the cloud. FIG. 5 illustrates a unidirectional dataflow from a source client station to a target client station. In a full system, the data would flow in both directions. However, since this data flow is symmetric, FIG. 5 depicts a one way for simplicity.

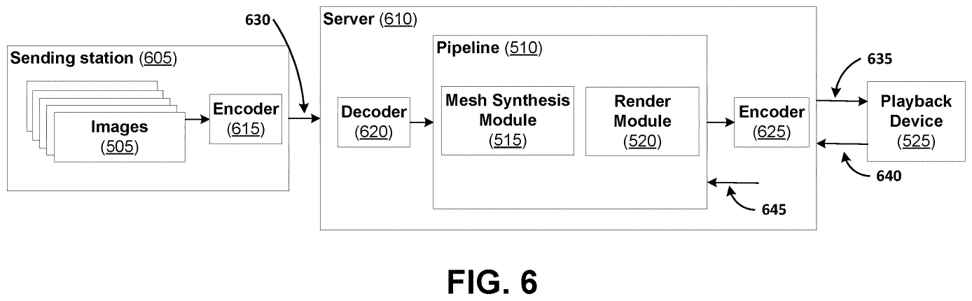

FIG. 6 illustrates a block diagram of a cloud-based streaming pipeline according to an example implementation. In an example implementation, a reduced amount of computing (as compared to the example system of FIG. 5) can be performed on both client stations and an increased amount of computing (as compared to the example system of FIG. 5) can be performed in the cloud. As shown in FIG. 6, in addition to the elements shown in FIG. 5, the cloud-based streaming pipeline can include a sending station 605 and a server 610. Sending station 605 can include an encoder 615. The server 610 can include a decoder 620 and an encoder 625. Sending station 605 can be communicatively coupled with server 610 via channel 630. The server 610 can be communicatively coupled with the playback device 525 via channel 635 and channel 640. Although not shown, playback device 525 can include a decoder.

In some implementations, a plurality (e.g., two or more, five, six, seven, and the like) time-synchronized 4 k video streams can be communicated from a sending station 605 to a cloud worker on, for example, a server 610. The number of time-synchronized 4 k video streams can be based on, for example, a number of cameras used in video conference system. The pipeline 510 (e.g., as a cloud worker) on the server 610 can run a machine learning model to generate a layered mesh. A layered mesh can be based on a plurality of 2D images forming a 3D representation of a scene. For example, a Multi-sphere images (MSI) can be generated based on the plurality of 2D images using a machine learning model. The MSI can include 3D layers representing a scene. A layered mesh can be generated based on the MSI using a layer reduction technique. The layered mesh can be a surface mesh corresponding to the surfaces in the scene. In other words, each layer of the layered mesh is a mesh representation of each sphere (e.g., the 3D layers) in the MSI. For example, the layered mesh can be planes initialized at varying depths (e.g., parallel to camera/person) instead of spheres at different radius. Layered meshes can then be deformed based on estimated depths.

Each layer can sometimes be called a depth layer. A depth layer can include depth information and features associated with the scene at the associated depth. The cloud worker can then use the layered mesh and a receiving station's latest viewer head pose estimate to render two RGB+depth views. The two rendered RGB+depth views can be streamed to the receiving station where the two RGB+depth views can be rendered with a final last-second viewer head pose correction.

In some implementations, the sending station 605 can perform the type of processing that can be achieved by mobile systems on chip (SOCs) and, possibly, inexpensive graphics processing units (GPUs). For example, the encoder 615 can be configured to perform video encoding (e.g., video compression) and multiplexing (MUX′ing).

In some implementations, the sending station can be configured to generate images 505 and the encoder 615 can be configured to encode the images 505 to generate an encoded video stream(s). The encoded video stream(s) can be communicated or streamed to the cloud via channel 630. Channel 630 can be a wired and/or wireless communication channel that uses a communication standard. The encoded video stream(s) can be decoded by the decoder 620 in the cloud at the server 610 and then input to a primary compute stage of the pipeline 510. This stage can be configured to compute a 3D representation (e.g., the RGB+Depth images described below) that can be encoded by the encoder 625 and streamed to the playback device 525 (e.g., as a target client station). The computing stages of server 610 in FIG. 6 may or may not run on the same machine or even in the same program.

In FIG. 6, the media dataflow is from left to right, from, for example, sending station 605 (e.g., as a source client station) to playback device 525 (e.g., as a target client station). However, there can be at least one stream of data that flows the other direction. For example, a stream of data flowing from the playback device 525 to the server 610 via channel 640 can include information associated with a viewpoint perspective and/or head pose 645 of a user of the playback device 525. This information can be the latest viewpoint perspective and/or head pose 645 information as measured at the playback device 525. Thus, pipeline 510 can use, for example, recent viewpoint perspective and/or head pose 645 information to create a light-weight 3D representation based on the viewpoints near that head pose. The light-weight 3D representation somewhat close to the viewpoint can be the preferred 3D representation and may degrade somewhat further away from the viewpoint. A stereo pair (e.g., left-eye and right-eye) of RGB+Depth images can be sufficient to give a desirable quality result from viewpoints near or based on the head pose. In some implementations, the layered mesh can be used to generate several sets of stereo RGB+Depth images where each set of stereo RGB+Depth images is optimized for different viewpoints and/or head poses.

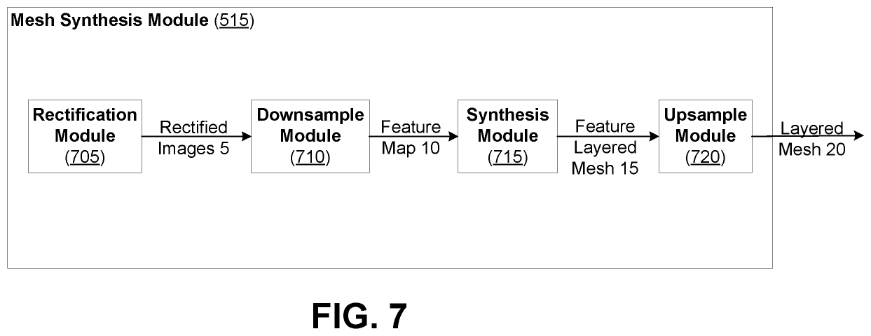

FIG. 7 illustrates a block diagram of a view synthesis system according to an example implementation. The view synthesis system can be configured to blend image weights and densities and reconstructs depth layers in the form of a layered mesh representation. The view synthesis system can be based on a DeepView algorithm. For example, the view synthesis system can be configured to generate a layered mesh output through a process of iterative refinement. As shown in FIG. 7, the mesh synthesis module 515 includes a rectification module 705, a downsample module 710, a synthesis module 715, and an upsample module 720.

The rectification module 705 can be configured to generate rectified images 5. In an example implementation, the rectification module 705 can be configured to reproject each of the images 505 to a layered mesh plane as the rectified images 5. In an example implementation, the layered mesh plane can be a near clipping plane. The rectification module 705 can be configured to decrease resolution of each of the images 505 during the reprojection of each of the images 505. The reprojection of each of the images 505 can ensure or help to ensure that image coordinates are consistent across each of the rectified images 5.

The downsample module 710 can be configured to downsample each of the rectified images 5 by, for example, eight times (8×) using, for example, a trained machine learning downsampling network. The machine learning downsampling network can be configured to generate low resolution feature maps 10 for each of the rectified images 5. The synthesis module 715 can be configured to generate a feature layered mesh 15. The feature layered mesh 15 can be a low-resolution layered mesh. In an example implementation, the feature layered mesh 15 can include 288×184 pixels×16 layers.

The upsample module 720 can be configured to generate layered mesh 20. In an example implementation, the upsample module 720 can be configured to increase the resolution of the feature layered mesh 15. In an example implementation, the upsample module 720 can be configured to increase a density 30 in resolution by, for example, eight times (8×). For example, the density 30 of the feature layered mesh 15 can be increased to a 1080p resolution. In an example implementation, the upsample module 720 can be configured to refine blend weights 25 of the feature layered mesh 15. However, the blend weight 25 and mesh vertices 35 of the layered mesh 20 can remain at a low resolution. Leaving the blend weights 25 and mesh vertices 35 at a low resolution can increase efficiency. For example, the final 3D image may not be sensitive to the resolution of blend weights 25 and mesh geometry. By contrast, the final 3D image can be sensitive to alpha and RGB resolution.

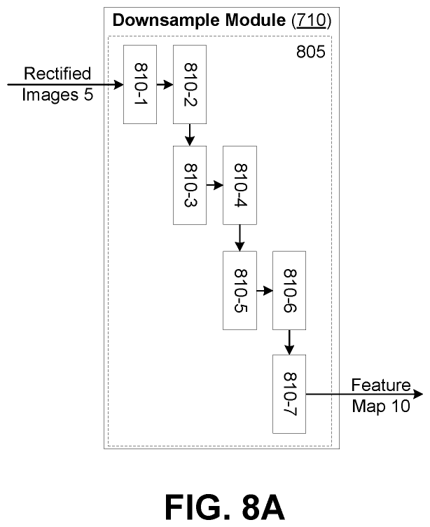

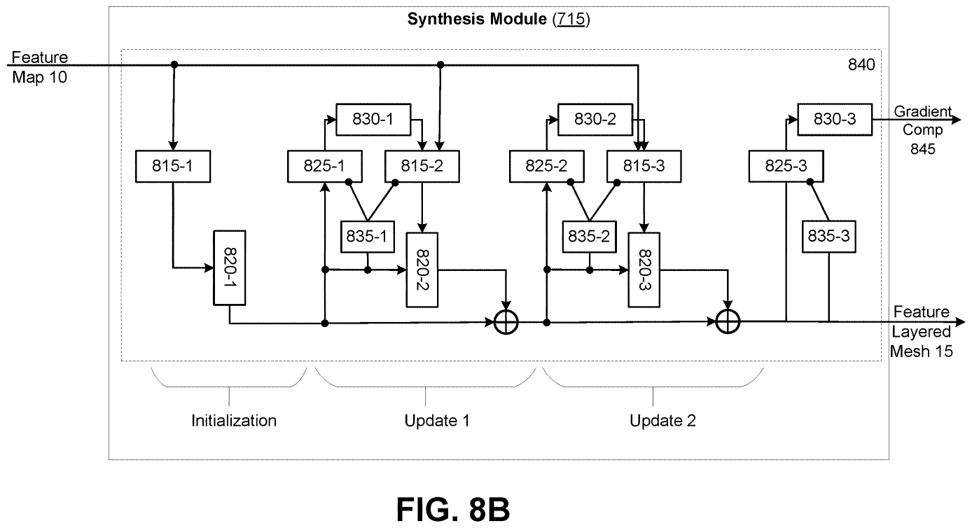

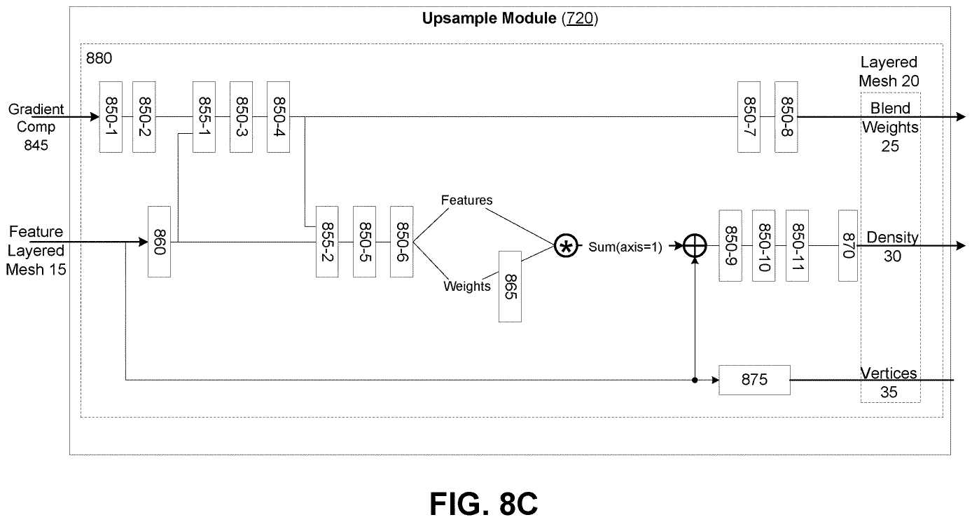

FIG. 8A illustrates a block diagram of an example machine learning downsampling network according to an example implementation as an example element (or implementation) of the downsample module 710. The machine learning downsampling network 805 can include a plurality of convolution layers 810-1, 810-2, 810-3, 810-4, 810-5, 810-6, 810-7. For example, the machine learning downsampling network 805 can include a series of strided convolutional layers. Therefore, the convolution layers 810-1, 810-2, 810-3, 810-4, 810-5, 810-6, 810-7 can be strided convolutional layers. Striding in a convolution layer indicates a number of pixels the filter matrix of the convolution layer moves across the input image. The stride length of a convolution layer indicates how many steps are taken when sliding the filter matrix across the image. In some implementations, the stride length of the convolution layers 810-1, 810-2, 810-3, 810-4, 810-5, 810-6, 810-7 can be one or two. For example, convolution layers 810-1, 810-3, 810-5, and 810-7 can have a stride length of one and convolution layers 810-2, 810-4, and 810-6 can have a stride length of two.

The plurality of convolution layers 810-1, 810-2, 810-3, 810-4, 810-5, 810-6, 810-7 can be configured to reduce the resolution of the rectified images 5. For example, the resolution of the rectified images 5 can be reduced by eight times (8×). For example, convolution layers 810-3, 810-4 can be configured to reduce the resolution of the rectified images 5 by two times (2×), convolution layers 810-5, 810-6 can be configured to reduce the resolution of the rectified images 5 by two times (2×), and convolution layers 810-7 can be configured to reduce the resolution of the rectified images 5 by two times (2×) for a total resolution reduction of eight times (8×). In some implementations, the convolution layers 810-1, 810-2, 810-3, 810-4, 810-5, 810-6, 810-7 can be configured to increase each of the rectified images 5 channel count from, for example, 4 to 32 channels.

FIG. 8B illustrates a block diagram of an example machine learning view synthesis network according to an example implementation as an example element (or implementation) of the synthesis module 715. As shown in FIG. 8B, in an example implementation, the feature layered mesh 15 layers can be initialized to have a flat geometry and project the feature map 10 onto these layers to generate a plane sweep volume (PSV). Then, according to an example implementation, an initialization network (e.g., images to layers transition 815-1 and neural network 820-1 (e.g., a convolutional neural network (CNN))) can be configured to compute an initial estimate of the feature layered mesh 15 (e.g., then output of neural network 820-1 or LayeredMesh) based on the PSV. At this point, the feature layered mesh 15 layers can include network features (with 32 channels). In an example implementation, the first 30 channels of the machine learning view synthesis network can include abstract network features (e.g., the features do not have any particular physical interpretation, therefore the network can be free to use features of the feature layered mesh 15 in any useful way). However, in an example implementation, the final two channels of the feature layered mesh 15 can be used by the machine learning view synthesis network to derive depth and density information. Accordingly, the machine learning view synthesis network can be configured to generate (or learn to generate) features for learning depth and density information.

The feature layered mesh 15 generated by the initialization network can be refined via two successive update steps. A first update step (Update 1) can include layers to images transition 825-1, images to layers transition 815-2, neural network 820-2 (e.g., a CNN), visibility components 830-1, and an activation block 835-1. A second update step (Update 2) can include layers to images transition 825-2, images to layers transition 815-3, neural network 820-2 (e.g., a CNN), visibility components 830-2, and an activation block 835-2. During each update step, the current feature layered mesh 15 can be projected back into the input feature map 10. In some implementations, the current feature layered mesh 15 can be compared to determine how well the current feature layered mesh 15 can approximate the real imagery captured by the input cameras. However, the feature layered mesh 15 that has been projected back into the input feature map 10 can be used in any useful process. In an example implementation, when projecting the features of the feature layered mesh 15 into the viewpoint of the input feature map 10, a geometry derived from the second to last depth channel in the layered mesh can be used. This channel can be activated (e.g., activation block 835-1, 835-2, 835-3) with a tanh nonlinearity, scaled by the layer width, and added to a set of depth anchors (e.g., the output of activation block 835-1, 835-2, 835-3) that are equally spaced in disparity. Constructing geometry using this technique can prevent feature layered mesh 15 layers from overlapping, because each layer can inhabit the layers own unique disparity band.

The layer geometry can then be used to warp from a layer space to a view space (and back again). While in view space the last channel (e.g., the density feature) of the feature layered mesh 15 can be used to perform compositing operations that can help communicate visibility information across the layers. These visibility components 830-1, 830-2, 830-3 can be used or help the update network because the visibility components 830-1, 830-2, 830-3 can reason about occlusions and understand across-layer dependencies. The visibility components 830-1, 830-2, 830-3 can be accumulated over and include a net transmittance. Accumulated over can include the reconstruction of the scene from behind the plane, and the net transmittance can be the soft occlusion mask for the plane.

The computation of visibility components 830-1, 830-2, 830-3 can improve the functioning of machine learning view synthesis network, because the computation of visibility components can be the time when information is communicated between layers. To complete the update step, the visibility components 830-1, 830-2, 830-3 can be warped from each of the input view spaces back to a central layered mesh representation and then these features can be input into the update network. The update network can be configured to generate a delta that can be added via a residual connection to the layered mesh computed in the previous iteration. This can iteratively (e.g., a plurality of update steps) generate the feature layered mesh 15 based on the feature map 10. In Addition, activation block 835-3, layer to images 825-3, and visibility components 830-3 together can generate gradient computations 845. Alternatively (or in addition), the layer to images 825-3 can calculate visibility components 830-3 (as the gradient computations 845) based on the feature layered mesh 15 and the depth calculated by the activation block 835-3. This reconstruct, check, and then refine strategy implemented in the update steps can be repeated several times, and strategy can function like an iterative optimization algorithm. Convergence to a high-quality solution can occur in a few (e.g., three) iterations.

FIG. 8C illustrates a block diagram of an example machine learning upsampling network according to an example implementation as an example element (or implementation) of the upsample module 720. As shown in FIG. 8C, in an example implementation, the machine learning upsampling network 880 can use the feature layered mesh 15 computed by the view synthesis network 840 and a final set of visibility components (gradient computations 845), and then processes these using a series of convolutions 850-1, 850-2, 850-3, 850-4, 850-5, 850-6, 850-7, 850-8, 850-9, 850-10, and 850-11, concatenations 855-1, 855-2, and a squeeze and excitation network (including the features and weights, a softmax 865 with the multiplication and addition elements) to estimate a low-resolution blend weight 25, mesh vertex 35 positions, and higher resolution density 30 layers of the layered mesh 20. In some implementations, the convolutions 850-7, 850-8 can be referred to as a blend model and the convolutions 850-9, 850-10, 850-11 can be referred to as a density model. In an example implementation, the above-mentioned density 30 layers can be upsampled via a depth2space transform 870. In some implementations, the feature layered mesh 15 (e.g., a second to last channel of the feature layered mesh 15) can be activated and converted 875 to produce a tensor containing 3D mesh vertex 35 locations.

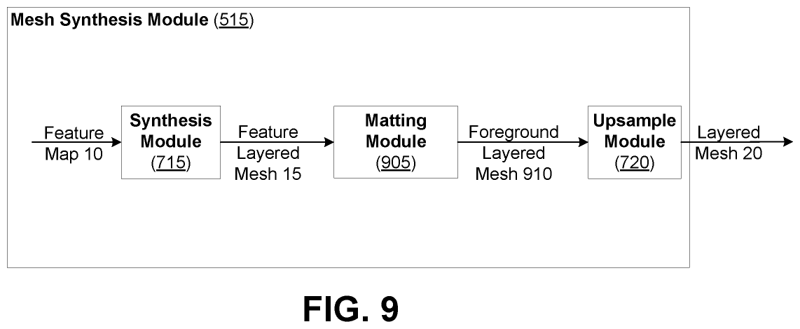

FIG. 9 illustrates another block diagram of a view synthesis system according to an example implementation. Example implementations can combine the machine learning model used for background removal with the machine learning model used for synthesizing a 3D mesh from a plurality of 2D images and/or the machine learning model used to render the synthesized 3D mesh. For example, the background subtraction model can be used to generate a background subtraction matte for ground truth training data. Then, training the synthesizing model on this ground truth data to create a background subtraction mask in its alpha channels in order to get the rendered results to match this ground truth result. Accordingly, the mesh synthesis module 115 can be modified to include a matting module 905. The matting module 905 can be configured to generate a foreground layered mesh 910 based on feature layered mesh 15. The matting module 905 can include a matting model.

During runtime, in some implementations, the matting model can be executed (e.g., run) on a target image and the rendering loss can be masked for background pixels using the matte. A loss between the total alpha and the matte can be added. A goal of this implementation can be to minimize haloing in the image with the background removed.

An example implementation can increase a weight in the machine learning model. The increased weight can increase the loss on the alpha matte and reduce the haloing. However, the haloing may not be completely removed, and foreground edges may be blurred.

Example implementations can include generating and/or compositing a random background on the target images. The same background can be used when rendering the image which can force the machine learning model to produce and alpha equal to 0 for the background.

An example implementation can simplify the random background by using one color. Example implementations can use a single-color random background than can minimize haloing and the blurring of foreground edges. Example implementations can be performed when removing a background using a combined machine learning model used for synthesizing a 3D image and removing a background of the 3D image.

In an alternative (or additional) example implementation a random noise background can be used. The image synthesis model can be configured to generate a semi-transparent layer(s) in 3D. These layers can be rendered from a different viewpoint to generate the final image. The machine learning model can assume the background to be black. Instead, in an example implementation, a random noise image can be used as the background. This random noise image can force the machine learning model to produce layers which are opaque such that the random noise may not be visible in the final image and can prevent the machine learning model from relying on a black background.

In an example implementation, in a machine learning training operation the background of the target image can be replaced with the same random noise. For example, a high-quality and slow matting model can be used to provide the matte used to replace the background. This can force the model to produce a transparent image for the background. The generated image may not suffer from haloing and can reproduce thin details. The increased quality can be explained by the power of the reconstruction loss used to train the model. In an example implementation, a Learned Perceptual Image Patch Similarity (LPIPS) metric can be used to compare image features at multiple scales. The added benefit of this implementation can be the simplicity as the matting objective is folded into the rendering loss.

### Example 1

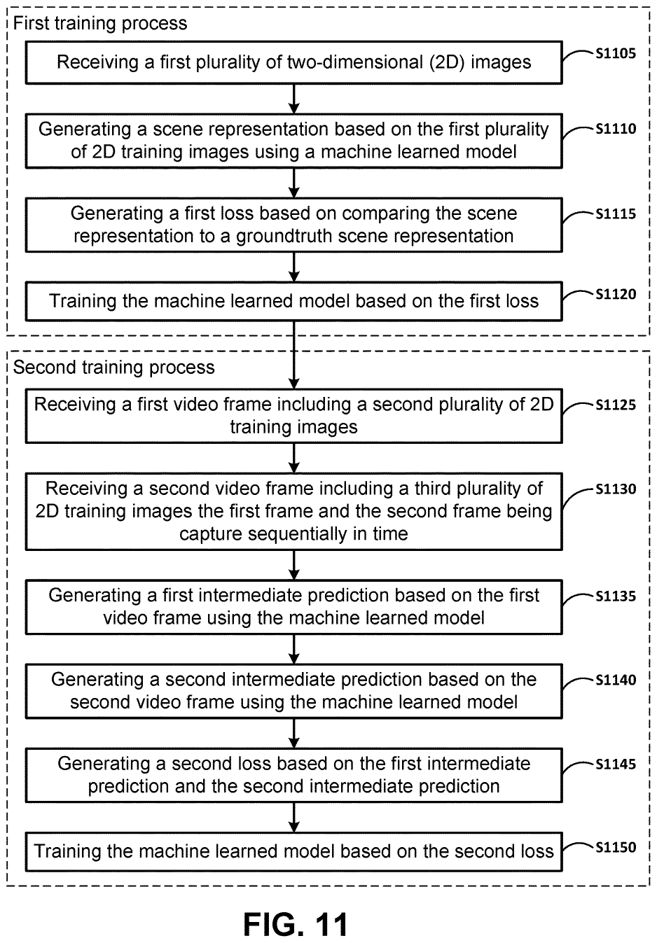

FIG. 11 illustrates a block diagram of a method of training an initially untrained machine learning model according to an example implementation. As shown in FIG. 11, [First training process] in step S1105 receiving a first plurality of two-dimensional (2D) training images. The first plurality of two-dimensional (2D) training images can represent video frames including training images that are captured by a camera, for example by a camera of a camera rig. In step S1110 generating a scene representation based on the first plurality of 2D training images using a machine learning model. Generating the scene representation can be used to refer to decomposing a single visual scene in one or all of the multiple of 2D training images that contains multiple objects into a combination of multiple individual objects. The machine learning model can be configured to render the scene representation as a 3D multiplane image (MPI) where each plane has a depth. A plane depth or depth layer can include depth information and features associated with the scene at the associated depth.

In step S1115 generating a first loss based on comparing the scene representation to a ground-truth scene representation. The ground-truth scene representation can be provided as a reference scene representation where the individual objects in the raw image data have been many manually defined for training the machine learning model. The loss can be generated based on (or using) a loss function measuring the disagreement between predicted and observed measurements. In step S1120 training the machine learning model based on the first loss. Here, training the machine learning model based on the first loss can be understood as training the machine learning model with the first loss. The first loss may be found as minimized when the loss, e.g. a value indicating the loss remains within a pre-defined first threshold range.

[Second training process] In step S1125 receiving a first video frame including a second plurality of 2D training images. The second plurality of 2D training images can be different than the first plurality of 2D training images. In step S1130 receiving a second video frame including a third plurality of 2D training images the first frame and the second frame being captured sequentially in time. Here, the third plurality of 2D training images can be different than the first and second plurality of 2D training images. In step S1135 generating a first intermediate prediction based on the first video frame using the machine learning model. In step S1140 generating a second intermediate prediction based on the second video frame using the machine learning model. In step S1145 generating a second loss based on the first intermediate prediction and the second intermediate prediction. In step S1150 training the machine learning model based on the second loss. Here, training the machine learning model based on the second loss can be understood as training the machine learning model with the second loss. The second loss may be found as minimized when the loss, e.g. a value indicating the loss remains within a pre-defined second threshold range.

### Example 2

The method of Example 1, wherein the training of the machine learning model based on the first loss can include repeating the first training process until the first loss is minimized and changing weights associated with the machine learning model. The first loss may be found as minimized when the loss, e.g. a value indicating the loss remains within a pre-defined first threshold range.

### Example 3

The method of Example 1, wherein the training of the machine learning model based on the second loss can include repeating the second training process until the second loss is minimized and changing weights associated with the machine learning model. The second loss may be found as minimized when the loss, e.g. a value indicating the loss remains within a pre-defined second threshold range.

### Example 4

The method of Example 1, wherein the first loss can be a feature loss.

### Example 5

The method of Example 1, wherein the first loss is a gradient of a loss function.

### Example 6

The method of Example 1, wherein the first intermediate prediction and the second intermediate prediction can include at least one of a density and a blend weight.

### Example 7

The method of Example 6, wherein the first intermediate prediction and the second intermediate prediction can be one of a 3D multiplane image (MPI) or a layered mesh and the density can be a transparency of each layer.

### Example 8

The method of Example 6, wherein the first intermediate prediction and the second intermediate prediction can be one of a 3D multiplane image (MPI) or a layered mesh and the blend weight can indicate an amount of color to use from an input image to color a pixel of the MPI or layered mesh.

### Example 9

The method of Example 1, wherein the scene representation can be a three-dimensional multiplane image.

### Example 10

The method of Example 1, wherein first video frame and the second frame can be included in a training dataset and can be capture using a framerate that minimizes a geometry change between first video frame and the second frame. The geometry change may be found as minimized when the geometry change, e.g. a value indicating the geometry change remains within a pre-defined threshold range.

### Example 11

The method of Example 1, can further include in the first training process storing the first loss as a stored first loss. In a third training process performing the steps of the second training process and generating a third loss based on the stored first loss and a weighted second loss.

### Example 12

The method of Example 1, can further include, in a third training process, performing the steps of the first training process, performing the steps of the second training process, and generating a third loss based on the first loss and a weighted second loss.

### Example 13

The Method of Example 1, Wherein the Second Training Process can Minimize a Difference Between the First Intermediate Prediction and the Second Intermediate Prediction to Temporally Regularize the Machine Learning Model

### Example 14

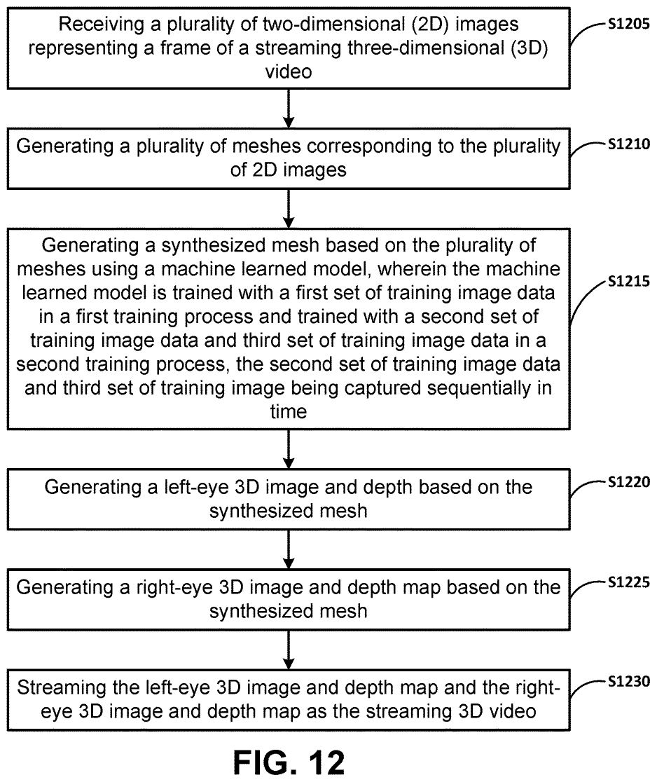

FIG. 12 illustrates a block diagram of a method according to an example implementation. As shown in FIG. 12, in step S1205 receiving a plurality of two-dimensional (2D) images representing a frame of a streaming three-dimensional (3D) video. In step S1210 generating a plurality of meshes corresponding to the plurality of 2D images. In step S1215 generating a synthesized mesh based on the plurality of meshes using a machine learning model, wherein the machine learning model is trained with a first set of training image data in a first training process and trained with a second set of training image data and third set of training image data in a second training process, the second set of training image data and third set of training image being captured sequentially in time. In step S1220 generating a left-eye 3D image and depth based on the synthesized mesh. In step S1225 generating a right-eye 3D image and depth map based on the synthesized mesh. In step S1230 streaming the left-eye 3D image and depth map and the right-eye 3D image and depth map as the streaming 3D video. Here, a single 2D image can represent a single frame. The term “frame” can be understood as a single image that, when played in sequence with the other frames of the video, creates motion on the playback surface. A mesh of the plurality of meshes can be generated for each one of the plurality of 2D images. The step of generating S1120 can refer to synthesizing or fusing the plurality of 2D images into a 3D representation of a scene. The viewpoint perspective can be the perspective of a user receiving the streaming of the 3D images on a 3D playback device.

### Example 15

The method of Example 14, wherein the head pose can be based on a viewpoint perspective of the user of the second client device receiving the frame of the streaming 3D video and the plurality of 2D images can have a different viewpoint perspective as compared to the viewpoint perspective of the user of the second client device.

### Example 16

The method of Example 14, wherein the generating of the plurality of meshes can includes downsampling the plurality of 2D images to generate a plurality of feature maps corresponding to one of the plurality of 2D images and generating the plurality of meshes based on the plurality of feature maps.

### Example 17

The method of Example 16, wherein the generating of the left-eye 3D image and depth map and the generating of the right-eye 3D image and depth map can include synthesizing the plurality of feature maps as a feature layered mesh, upsampling the feature layered mesh as a layered mesh, and generating the left-eye 3D image and depth map and generating the right-eye 3D image and depth map based on the layered mesh.

### Example 18

The method of Example 17, wherein the synthesizing of the plurality of feature maps can include initializing the plurality of feature maps to have a flat geometry and projecting the plurality of feature maps to generate a plane sweep volume (PSV).

### Example 19

The method of Example 17, wherein the feature layered mesh can include a plurality of channels, a first subset of the plurality of channels can include abstract network features, and a second subset of the plurality of channels can include depth and density information.

### Example 20

The method of Example 17, wherein the synthesizing of the plurality of feature maps can include generating visibility components to identify occlusions and cross-layer dependencies.

### Example 21

The method of Example 17, wherein the synthesizing of the plurality of feature maps can include projecting the feature layered mesh onto at least one of the plurality of feature maps to determine how well the feature layered mesh approximates at least one of the plurality of 2D images. Alternatively, or additionally, the synthesizing of the plurality of feature maps can include projecting the feature layered mesh onto at least one of the plurality of feature maps and comparing to at least one of the plurality of 2D images to determine an approximation of the feature layered mesh to the at least one of the plurality of 2D images. Alternatively, or additionally, the synthesizing of the plurality of feature maps can include projecting the feature layered mesh onto at least one of the plurality of feature maps and comparing the result to at least one of the plurality of 2D images to determine whether a difference between the feature layered mesh to the at least one of the plurality of 2D images meets a criteria. The criteria can include a per pixel delta threshold, a region of pixels average delta threshold, an object pixel delta threshold, a total loss threshold, a peak signal-to-noise ratio (PSNR), and the like.

### Example 22

The method of Example 14 generating of the plurality of meshes can include downsampling the plurality of 2D images to generate a plurality of feature maps corresponding to one of the plurality of 2D images, generating the plurality of meshes based on the plurality of feature maps, and applying an image matte to the plurality of meshes to remove a background associated with the plurality of 2D images to generate a plurality of foreground meshes.

### Example 23

The method of Example 22, wherein the applying of the image matte can include using a single-color random background.

### Example 24

The method of Example 22, wherein the applying of the image matte can include using a random noise background.

### Example 25

The method of Example 14 can further include receiving a viewpoint perspective and/or head pose of a user of a playback device.

### Example 26

The method of Example 14, wherein a head pose of the user can be a first head pose, the method can further include receiving, from the second client device, a second head pose of the user of the second client device, the second head pose being generated later in time than the first head pose, wherein the plurality of meshes corresponding to the plurality of 2D images can be generated based on the first head pose, the left-eye 3D image and depth map can be generated based on the second head pose, and the right-eye 3D image and depth map can be generated based on the second head pose.

### Example 27

A method can include any combination of one or more of Example 1 to Example 26.

### Example 28

A non-transitory computer-readable storage medium comprising instructions stored thereon that, when executed by at least one processor, are configured to cause a computing system to perform the method of any of Examples 1-27.

### Example 29

An apparatus comprising means for performing the method of any of Examples 1-27.

### Example 30

An apparatus comprising at least one processor and at least one memory including computer program code, the at least one memory and the computer program code configured to, with the at least one processor, cause the apparatus at least to perform the method of any of Examples 1-27.

Example implementations can include a non-transitory computer-readable storage medium comprising instructions stored thereon that, when executed by at least one processor, are configured to cause a computing system to perform any of the methods described above. Example implementations can include an apparatus including means for performing any of the methods described above. Example implementations can include an apparatus including at least one processor and at least one memory including computer program code, the at least one memory and the computer program code configured to, with the at least one processor, cause the apparatus at least to perform any of the methods described above.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (a LED (light-emitting diode), or OLED (organic LED), or LCD (liquid crystal display) monitor/screen) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the specification.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

While example embodiments may include various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of the claims. Like numbers refer to like elements throughout the description of the figures.

Some of the above example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed above, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

Specific structural and functional details disclosed herein are merely representative for purposes of describing example embodiments. Example embodiments, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term and/or includes any and all combinations of one or more of the associated listed items.

It will be understood that when an element is referred to as being connected or coupled to another element, it can be directly connected or coupled to the other element or intervening elements may be present. In contrast, when an element is referred to as being directly connected or directly coupled to another element, there are no intervening elements present. Other words used to describe the relationship between elements should be interpreted in a like fashion (e.g., between versus directly between, adjacent versus directly adjacent, etc.).

The terminology used herein is for the purpose of describing particular embodiments only and is not intended to be limiting of example embodiments. As used herein, the singular forms a, an and the are intended to include the plural forms as well, unless the context clearly indicates otherwise. It will be further understood that the terms comprises, comprising, includes and/or including, when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the above example embodiments and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the above illustrative embodiments, reference to acts and symbolic representations of operations (e.g., in the form of flowcharts) that may be implemented as program modules or functional processes include routines, programs, objects, components, data structures, etc., that perform particular tasks or implement particular abstract data types and may be described and/or implemented using existing hardware at existing structural elements. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as processing or computing or calculating or determining of displaying or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example embodiments are typically encoded on some form of non-transitory program storage medium or implemented over some type of transmission medium. The program storage medium may be magnetic (e.g., a floppy disk or a hard drive) or optical (e.g., a compact disk read only memory, or CD ROM), and may be read only or random access. Similarly, the transmission medium may be twisted wire pairs, coaxial cable, optical fiber, or some other suitable transmission medium known to the art. The example embodiments not limited by these aspects of any given implementation.

1. A method comprising:
in a first training process:
receiving a first plurality of two-dimensional (2D) training images;
generating a scene representation based on the first plurality of 2D training images using a machine learning model;
generating a first loss based on comparing the scene representation to a ground-truth scene representation; and
training the machine learning model based on the first loss; and
in a second training process:
receiving a first video frame including a second plurality of 2D training images;
receiving a second video frame including a third plurality of 2D training images the first frame and the second frame being captured sequentially in time;
generating a first intermediate prediction based on the first video frame using the machine learning model;
generating a second intermediate prediction based on the second video frame using the machine learning model;
generating a second loss based on the first intermediate prediction and the second intermediate prediction; and
training the machine learning model based on the second loss.

2. The method of claim 1, wherein the training of the machine learning model based on the first loss comprises:
repeating the first training process until the first loss is minimized; and
changing weights associated with the machine learning model.

3. The method of claim 1, wherein the training of the machine learning model based on the second loss comprises:
repeating the second training process until the second loss is minimized; and
changing weights associated with the machine learning model.

4. The method of claim 1, wherein the first loss is a feature loss.

5. The method of claim 1, wherein the first loss is a gradient of a loss function.

6. The method of claim 1, wherein the first intermediate prediction and the second intermediate prediction include at least one of a density and a blend weight.

7. The method of claim 6, wherein:
the first intermediate prediction and the second intermediate prediction are one of a 3D multiplane image (MPI) or a layered mesh, and
the density is a transparency of each layer of the MPI or the layered mesh.

8. The method of claim 6, wherein:
the first intermediate prediction and the second intermediate prediction are one of a 3D multiplane image (MPI) or a layered mesh, and
the blend weight indicates an amount of color to use from an input image to color a pixel of the MPI or layered mesh.

9. The method of claim 1, wherein the scene representation is a three-dimensional multiplane image.

10. The method of claim 1, wherein first video frame and the second frame are included in a training dataset and are capture using a framerate that minimizes a geometry change between first video frame and the second frame.

11. The method of claim 1, further comprising:
in the first training process:
storing the first loss as a stored first loss; and
in a third training process:
performing the steps of the second training process; and
generating a third loss based on the stored first loss and a weighted second loss.

12. The method of claim 1, further comprising:
in a third training process:
performing the steps of the first training process;
performing the steps of the second training process; and
generating a third loss based on the first loss and a weighted second loss.

13. The method of claim 1, wherein the second training process minimizes a difference between the first intermediate prediction and the second intermediate prediction to temporally regularize the machine learning model.

14-15. (canceled)

16. An apparatus comprising:
at least one processor; and
at least one memory including computer program code;
the at least one memory and the computer program code configured to, with the at least one processor, cause the apparatus at least to:
in a first training process:
receive a first plurality of two-dimensional (2D) training images;
generate a scene representation based on the first plurality of 2D training images using a machine learning model;
generate a first loss based on comparing the scene representation to a ground-truth scene representation; and
train the machine learning model based on the first loss; and
in a second training process:
receive a first video frame including a second plurality of 2D training images;
receive a second video frame including a third plurality of 2D training images the first frame and the second frame being captured sequentially in time;
generate a first intermediate prediction based on the first video frame using the machine learning model;
generate a second intermediate prediction based on the second video frame using the machine learning model;
generate a second loss based on the first intermediate prediction and the second intermediate prediction; and
train the machine learning model based on the second loss.

17. The apparatus of claim 16, wherein the first loss is a feature loss or a gradient of a loss function.

18. The apparatus of claim 16, wherein the first intermediate prediction and the second intermediate prediction include at least one of a density and a blend weight.

19. The apparatus of claim 18, wherein:
the first intermediate prediction and the second intermediate prediction are one of a 3D multiplane image (MPI) or a layered mesh, and
the density is a transparency of each layer of the MPI or the layered mesh.

20. The apparatus of claim 16, further comprising:
in a third training process:
performing the steps of the first training process;
performing the steps of the second training process; and
generating a third loss based on the first loss and a weighted second loss.

21. The apparatus of claim 16, wherein the second training process minimizes a difference between the first intermediate prediction and the second intermediate prediction to temporally regularize the machine learning model.

22. A non-transitory computer-readable storage medium comprising instructions stored thereon that, when executed by at least one processor, are configured to cause a computing system to:
in a first training process:
receive a first plurality of two-dimensional (2D) training images;
generate a scene representation based on the first plurality of 2D training images using a machine learning model;
generate a first loss based on comparing the scene representation to a ground-truth scene representation; and
train the machine learning model based on the first loss; and
in a second training process:
receive a first video frame including a second plurality of 2D training images;
receive a second video frame including a third plurality of 2D training images the first frame and the second frame being captured sequentially in time;
generate a first intermediate prediction based on the first video frame using the machine learning model;
generate a second intermediate prediction based on the second video frame using the machine learning model;
generate a second loss based on the first intermediate prediction and the second intermediate prediction; and
train the machine learning model based on the second loss.
